(19) United States
(12) Patent Application Publication
(10) Pub. No.: US 2013/0203277 A1
(43) Pub. Date: Aug. 8, 2013

(54) Electrical Connector

(71) Applicant: Zachary Gaubert, Dallas, TX (US)

(72) Inventor: Zachary Gaubert, Dallas, TX (US)

(21) Appl. No.: 13/367,566

(22) Filed: Feb. 7, 2012

(51) Int. Cl. H01R 13/627; H01R 13/52

(52) U.S. Cl. 439/271; 439/349

(57) ABSTRACT

An electrical plug connector is disclosed. The electrical plug connector can include an electrical plug, a plug housing, and a low profile latching feature. The plug housing can be fixedly coupled to the electrical plug with at least a portion of the electrical plug extending from the plug housing to allow the electrical plug to interface with an electrical receptacle to form an electrical connection. The low-profile latching feature can extend outward from the plug housing to engage a mating latching feature associated with the electrical receptacle.

### GOVERNMENT LICENSE RIGHTS

This invention was made with government support under Government Contract Number W56 HZV-09-C-0381, awarded by Research and Development, Ground Soldier System. The government has certain rights in the invention.

### BACKGROUND

Electrical devices are commonly coupled to peripheral electronic devices with a wire or a cord. Oftentimes, such devices and peripheral devices are used in rugged environments that can subject the devices and the couplings to external forces, such as snagging or tugging of a cord. Additionally, environmental elements, such as water, dust, dirt, or other debris can also present problems for electrical couplings. In response to these hazards, several approaches have incorporated features that increase retention force of couplings to resist unwanted unplugging of devices and/or provide protection for electrical devices from harmful environmental elements.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1A is an example illustration of an electrical connector system in accordance with an embodiment of the present invention.

FIG. 1B is a cross-sectional view of the electrical connector system of FIG. 1A in an engaged configuration.

FIG. 2A is a side view of an electrical plug connector in accordance with one embodiment of the present invention.

FIG. 2B is a side view of an electrical plug connector in accordance with another embodiment of the present invention.

FIG. 3 is an example illustration of an electrical connector system in accordance with another embodiment of the present invention.

FIG. 4 is an example illustration of a cover for an electrical receptacle connector in accordance with an embodiment of the present invention.

FIG. 5A is a perspective view of an electrical plug connector in accordance with still another embodiment of the present invention.

FIG. 5B is a side view of the electrical plug connector of FIG. 5A.

Reference will now be made to the exemplary embodiments illustrated, and specific language will be used herein to describe the same. It will nevertheless be understood that no limitation of the scope of the invention is thereby intended.

### DETAILED DESCRIPTION

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

Although current design approaches to increase electrical coupling retention force and/or provide environmental protection for electrical couplings are generally effective, the designs are typically bulky and can hinder use of the electrical devices and peripheral devices. For example, some designs utilize a threaded fastener or other coupling disposed about the coupling components that require twisting for engagement and retention. Such designs can greatly increase the size of a coupling, which can hinder use of devices and peripherals. The added bulk of such couplings can also deter potential users from enjoying the benefits of increased retention force and/or protection from harmful elements. Thus, users that require increased retention force and/or protection from harmful elements as well as other users for whom such advantages can be appreciated can benefit from more useful couplings.

Accordingly, an electrical plug connector is disclosed that maintains a low-profile to avoid adding unnecessary or undue size or bulk to a device or coupling. In one aspect, a seal is utilized or incorporated that protects an electrical connection from a harmful environment. The electrical plug connector includes an electrical plug, a plug housing, and a low-profile latching feature. The plug housing can be fixedly coupled to the electrical plug with at least a portion of the electrical plug extending from the plug housing to allow the electrical plug to interface with an electrical receptacle to form an electrical connection. The low-profile latching feature can extend outward from the plug housing to engage a mating latching feature associated with the electrical receptacle.

Furthermore, an electrical plug connector is disclosed that includes an electrical plug, a plug housing, and a seal. The plug housing can be fixedly coupled to the electrical plug with at least a portion of the electrical plug extending from the plug housing to allow the electrical plug to interface with an electrical receptacle to form an electrical connection. The seal can be disposed about an exterior of the plug housing and can be operable to interface with a receptacle housing associated with the electrical receptacle to form a seal between the plug housing and the receptacle housing. The seal can be at least partially exposed about the plug housing.

In addition, an electrical connector system is disclosed. The system can include an electrical receptacle connector and an electrical plug connector. The electrical receptacle connector can have an electrical receptacle and a receptacle latching feature extending from the electrical receptacle. The electrical plug connector can be operable to engage the electrical receptacle connector. The electrical plug connector can include an electrical plug, a plug housing, and a plug latching feature. The plug housing can be fixedly coupled to the electrical plug with at least a portion of the electrical plug extending from the plug housing to allow the electrical plug to interface with the electrical receptacle to form an electrical connection. The plug latching feature can extend outward from the plug housing and be operable to engage the receptacle latching feature to secure the electrical plug connector to the electrical receptacle connector.

A method of facilitating an electrical connection is also disclosed. The method can include providing an electrical plug connector configured to engage an electrical receptacle connector. The electrical plug connector can have an electrical plug, a plug housing, and a low-profile latching feature. The plug housing can be fixedly coupled to the electrical plug with at least a portion of the electrical plug extending from the plug housing to allow the electrical plug to interface with an electrical receptacle of the electrical receptacle connector to form an electrical connection. The low-profile latching feature can extend outward from the plug housing. Additionally, the method can include facilitating engagement of the electrical plug connector with the electrical receptacle connector.

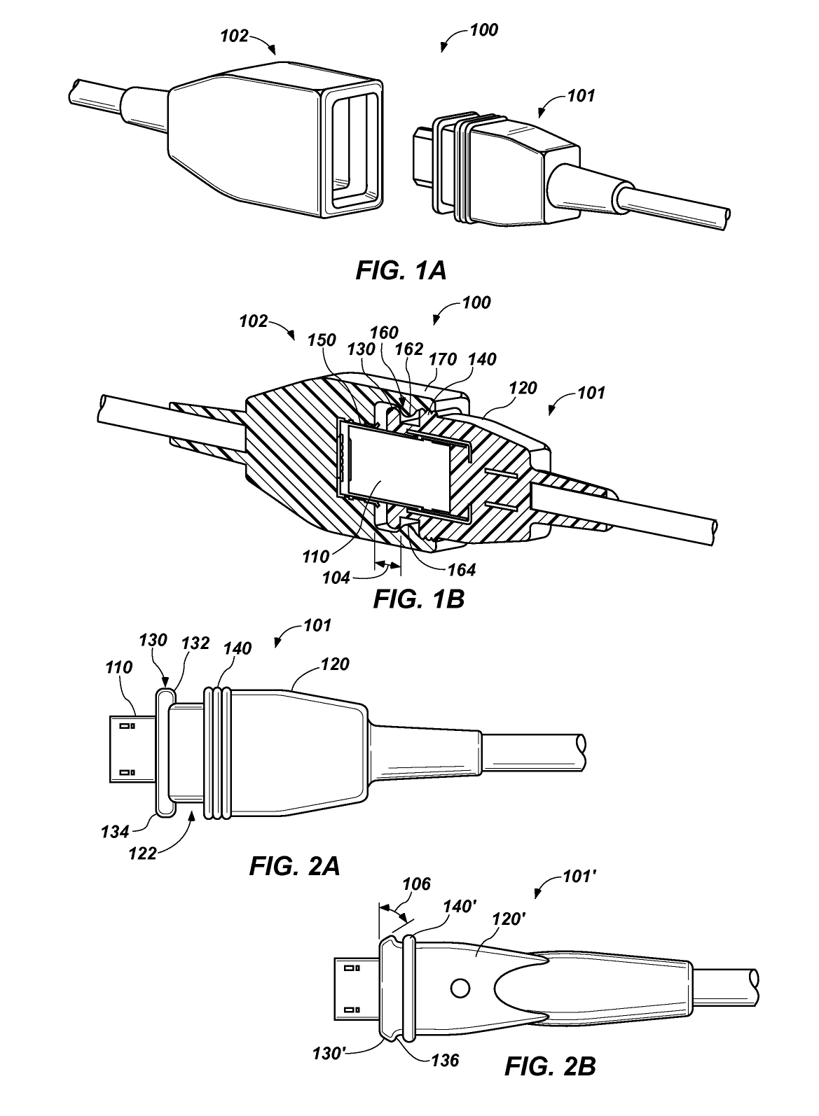

One embodiment of an electrical connector system 100 is illustrated in FIGS. 1A and 1B. The electrical connector system 100 can comprise an electrical plug connector 101 and an electrical receptacle connector 102. The electrical receptacle connector 102 can have an electrical receptacle 150 and a latching feature 160 extending from the electrical receptacle 150. The electrical plug connector 101 can be operable to engage the electrical receptacle connector 102. In general, the term “plug” refers to a “male” type of connector and the term “receptacle” refers to a “female” type of connector.

With reference to FIG. 2A and continued reference to FIGS. 1A and 1B, the electrical plug connector 101 can have an electrical plug 110 configured to mate with and engage the electrical receptacle 150. An electrical plug and/or receptacle can be any suitable type of electrical connector including, but not limited to, standardized connectors such as USB, micro USB, mini USB, headphone jack, RCA jack, etc., proprietary connectors such as those used on cell phone power supplies, or any other type of electrical connector. In other words, an extension cord or a device that couples to a cord can include a connector.

The plug connector 101 can also include a plug housing 120. The plug housing 120 can be fixedly coupled to the electrical plug 110 with at least a portion of the electrical plug 110 extending from the plug housing 120 to allow the electrical plug 110 to interface with the electrical receptacle 150 to form an electrical connection. In one aspect, the plug connector 101 can include a plug latching feature 130 extending outward from the plug housing 120. The plug latching feature can be operable to engage the mating receptacle latching feature 160 associated with the electrical receptacle 150. Thus, the mating plug latching feature 130 and receptacle latching feature 160 can secure the electrical plug connector 101 to the electrical receptacle connector 102.

In one aspect, the plug latching feature 130 can be defined, at least in part, by a reduced cross-sectional area portion 122 formed in the plug housing 120. The reduced cross-sectional area portion 122 of the plug housing 120 can be configured to at least partially receive the receptacle latching feature 160 associated with the electrical receptacle 150. It should be recognized that the plug latching feature 130 can be disposed about a circumference, or 360 degrees, about the plug housing 120. However, a plug latching feature 130 can be disposed about less than an entire circumference of the plug housing 120. For example, the plug latching feature 130 can comprise a plurality of non-contiguous portions extending from a surface of the plug housing 120. As shown in FIG. 2A, a first portion 132 and a second portion 134 of the plug latching feature 130 can extend from less than all (e.g., opposite sides) of the plug housing 120. Similarly, the reduced cross-sectional area 122 can be formed on less than all of the sides (e.g., two opposite sides) of the plug housing 120.

By including latching feature portions 132, 132 on only part of a circumference of the plug housing 120, the overall size of the latching feature 130 can be kept small enough to maintain a low profile of the latching feature 130 around the plug housing 120. A low profile latching feature 130 can have several advantages. For example, when coupling with a receptacle in a low profile device, such as a laptop or cell phone, the low profile plug latching feature 130 of a plug connector 101 can maintain the low profile nature of the device without necessitating a bulky housing associated with the receptacle in order to accommodate the plug connector 101. In addition, a plug connector 101 with a low profile latching feature may be used with a receptacle that is not associated with a housing that is compatible with the locking feature 130. In other words, the plug connector 101 with a low profile latching feature 130 can be used with a standard receptacle connector without any mating locking feature. In such cases, the low profile latching feature 130 can be sized to allow a plug connector 101 to fit next to an adjacent plug connector, with or without a low profile locking feature (e.g., one that is standard), when both are coupled with receptacle connectors. Thus, in one aspect, the plug housing 120 and the plug latching feature 130 can be within or comply with an industry standard size envelope in at least one direction that ensures that the electrical plug 110 is capable of interfacing with industry standard electrical receptacles without interference from the plug housing 120, the plug latching feature 130, or an adjacent or neighboring electrical plug connector. The USB standard for connectors may include such a size envelope. Accordingly, the plug connector 101 with a low profile latching feature 130 can be a universal connector in that the plug connector 101 can mate with any standard receptacle, as well as a receptacle with a matching latching feature. In another aspect, the low profile plug latching feature 130 does not extend past a portion of the plug 110 that interfaces with a receptacle. This can enable the plug connector 101 to couple with receptacles having associated housings and latching features as well as those that do not have such features.

With further reference to FIG. 1B, the electrical receptacle connector 102 can have an inwardly extending receptacle latching feature 160 to mate with the outwardly extending plug latching feature 130 of the plug connector 101. The receptacle latching feature 160 can be located in a position offset 104 from an open end of the electrical receptacle 150. In other words, the receptacle latching feature 160 can be located beyond an open end of the electrical receptacle 150 to engage the plug latching feature 130. An opening of the receptacle housing 170 configured to receive the plug connector 101 can be configured to approximate the general shape of the electrical receptacle 150. In other words, for example, a rectangular opening of the receptacle housing 170 can follow from a generally rectangular opening for the electrical receptacle 150. By maintaining the approximate shape of the electrical receptacle 150 opening with the opening for the receptacle housing 170, the plug latching feature 130 of the plug connector 101 can be configured to maintain a low profile.

Similar to the plug latching feature 130, the receptacle latching feature 160 can include a plurality of non-contiguous portions 162, 164 extending from the receptacle housing 170 of the electrical receptacle connector 102 in order to mate with and engage a plurality of non-contiguous portions, such as portions 132, 134, extending from the plug housing 120. For example, non-contiguous portions 162, 164 can extend inwardly from the receptacle housing 170 of the electrical receptacle connector 102 to mate with and engage the non-contiguous portions 132, 134 extending outwardly from the plug housing 120. In one aspect, the plug latching feature 130 and/or the receptacle latching feature 160 can be elastically deformable to facilitate engagement with the respective mating latching feature.

In one aspect, the plug connector 101 can include a seal 140 disposed about an exterior of the plug housing 120. The seal 140 can be operable to interface with a receptacle housing 170 associated with the electrical receptacle 150 to form a seal between the plug housing 120 and the receptacle housing 170. For example, the seal 140 can form a barrier protecting the electrical connection from environmental conditions. In a specific aspect, the seal 140, or at least a portion thereof, can be exposed as situated or disposed about the plug housing 120. In other words, the seal 140 can be exposed unless interfacing with the receptacle housing 170 associated with the electrical receptacle 150. In one aspect, the seal can be disposed around the entire circumference, or 360 degrees, of the plug housing 120. It should be recognized that the plug connector 101 can include either one or both of the plug latching feature 130 and the seal 140.

To provide a good seal with the receptacle connector 102, the seal 140 can extend at least as far away from a surface of the plug housing 120 as any portion of the latching feature 130. This can enable the housing 170 of the receptacle connector 102 to be configured for good contact with the seal 140 while allowing the latching feature 130 to pass through the opening of the housing 170 relatively unobstructed until encountering the latching feature 160 of the receptacle connector 102. As discussed above with regard to the low profile nature of the latching feature 130, the seal 140 can also exhibit low profile characteristics. For example, the seal 140 can extend from the surface of the plug housing only to the extent necessary to provide a good seal with the receptacle connector 102. This can minimize the profile of the seal 140 and maintain the advantages of a low profile latching feature 130. When sealed, the electrical connector system 100 can be resistant to water and/or debris. For example, a sealed electrical connector system 100 can comply with Military Standard 810G for immersion, rain, dust, and humidity resistance, among other things.

In one aspect, the latching feature 130 of the plug housing 120 can be defined, at least in part, by a portion of the seal 140. In other words, the seal 140 can make up a portion of a wall of the reduced cross-sectional area portion 122 of the plug housing 120. Accordingly, the plug housing 120, latching feature 130 and/or seal 140 can be a single molded construction. It should be recognized, however, that the seal 140 can be a separate component, such as an o-ring, and the plug housing 120 can be configured with a groove or channel to maintain the o-ring in the desired location on the plug housing 120. As shown in FIG. 2A, the seal 140 can include multiple sealing portions or o-rings.

Although, the plug connector 101 is described above as including a seal 140, it should be recognized that the receptacle connector 102 can include a seal, in addition or as an alternative to the seal 140, operable to interface with the plug housing 120 to seal the electrical receptacle connector 102 and the electrical plug connector 101. In this case, for example, the electrical receptacle connector 102 can include an inwardly extending seal to interface with the plug housing 120 to form a barrier protecting the electrical connection from environmental conditions. In one aspect, the seal can be disposed around the entire circumference, or 360 degrees, of the receptacle housing 170.

Electrical connections, due to physical contact between mating components, such as a plug and receptacle, can have an inherent amount of retention force that functions to counteract a force tending to separate or decouple the mating components, thereby breaking the electrical connection. The plug latching feature 130 of the plug connector 101 and receptacle latching feature 160 of the receptacle connector 102 and/or the seal 140 of the plug connector 101 can increase the retention force of the connector system 100 over that inherent in the plug 110 and receptacle 150. The additional retention force can be configured to resist unwanted separation of the plug connector 101 and receptacle connector 102. It should be recognized that the electrical connector system 100 can achieve increased retention force and/or sealing without any moving parts. For example, the latching features 130, 160 utilize a geometric interference as opposed to a threaded or twisting engagement, which can necessitate a circular shape that can increase the overall size of the connectors. Thus, the latching features 130, 160 can result in a smaller or lower profile electrical connector system over connector systems that utilize threaded or twisting engagements to increase retention force.

Shown in FIG. 2B is another embodiment of plug connector 101′. In this embodiment, the latching feature 130′ can be configured to require relatively low force for inserting or coupling the plug connector 101′ with a mating receptacle connector compared to a force required to separate or decouple the plug connector 101′ from the receptacle connector. For example, the latching feature 130′ can include a leading surface or edge formed at an angle 106 that is relatively shallow compared to the steep lip 136 on the back side of the latching feature 130′. Additionally, this embodiment illustrates a seal 140′ having only a single sealing portion or o-ring.

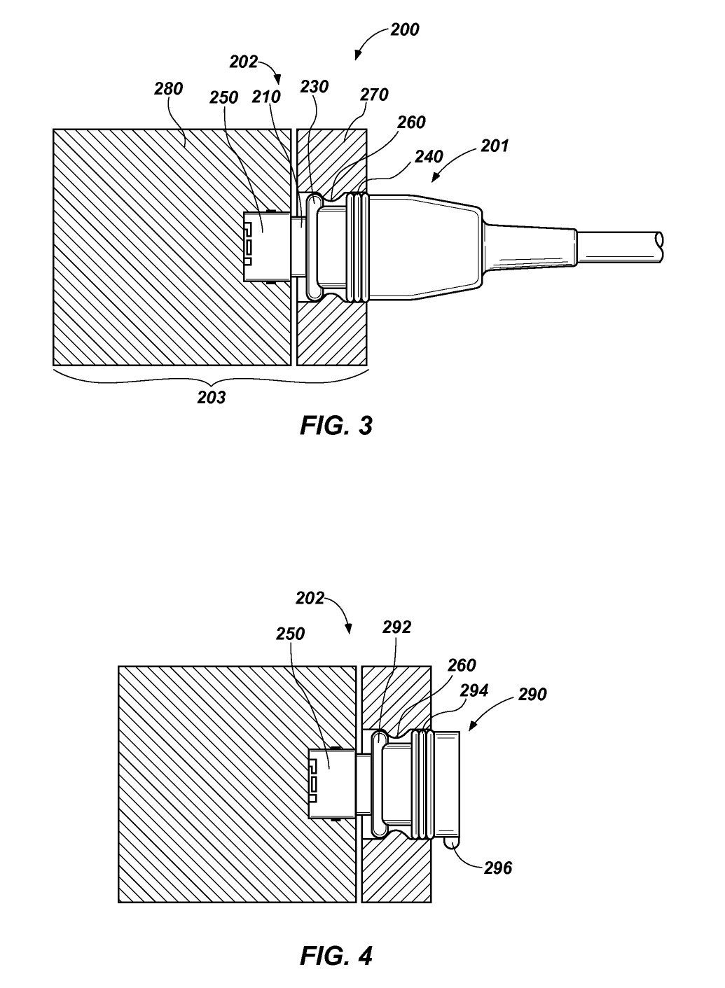

With reference to FIG. 3, illustrated is another embodiment of an electrical connector system 200. This embodiment shows a receptacle connector 202 incorporated with a device 203, such as a laptop or a cell phone. In this case, the electrical receptacle 250 can be coupled to a circuit board 280 of the device 203. The housing 270 associated with the electrical receptacle 250 can include a latching feature 260 configured to mate with and engage a latching feature 230 of a plug connector 201. The housing 270 associated with the electrical receptacle 250 can be a housing of the device 203. For example, in one aspect, the housing 270 can be an OEM laptop case or OEM cell phone body. In another aspect, the housing 270 can be retrofitted to enclose a laptop or cell phone, such as a protective cover or case. As with the examples discussed above, the electrical connector system 200 can include a seal 240. The result of this configuration can be a low profile electrical connector system 200 that can increase retention force and/or provide a seal for the connection between the electrical plug 210 and the receptacle 250 without overly increasing the bulk of the device 203.

Illustrated in FIG. 4 is a cover 290 that can be used with an electrical receptacle connector 202 in the absence of an electrical plug connector, such as plug connector 201 in FIG. 3. The cover 290 can be operable to protect the electrical receptacle 250 from environmental conditions when the receptacle connector 202 is not coupled with a plug connector. The cover 290 can have a cover latching feature 292 operable to mate with and engage the receptacle latching feature 260 of the electrical receptacle connector 202. For example, the cover 290 can have an outwardly extending cover latching feature 292 to engage the receptacle latching feature 260. To provide a barrier or protection from environmental conditions, the cover 290 can include a seal 294, similar to other seals discussed herein. Additionally, to allow a user to remove the cover 290 from the receptacle connector 202, the cover 290 can include a tab 296 or other feature that that can be grasped or manipulated by the user to remove the cover 290 from the receptacle connector 202.

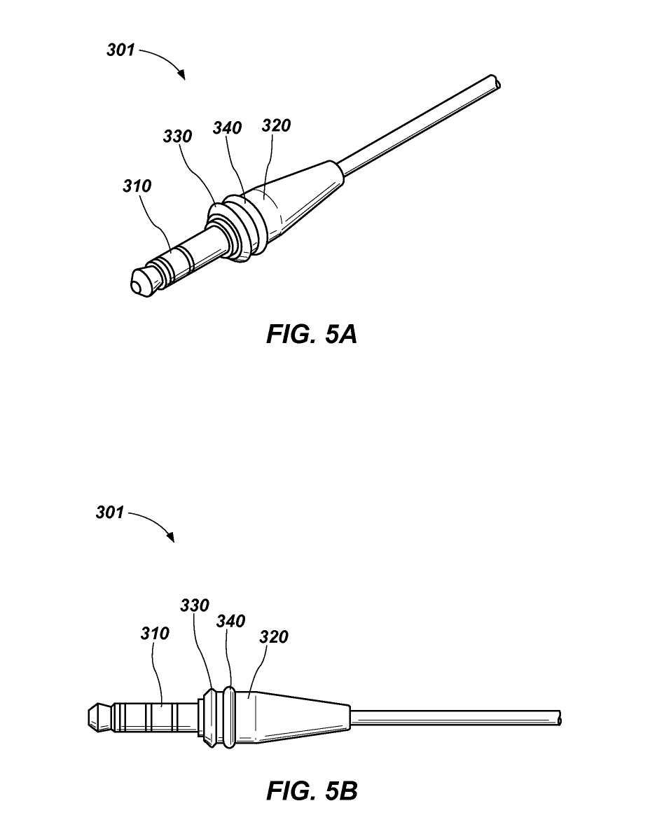

As mentioned above, an electrical plug and/or receptacle can be any suitable type of electrical connector. FIGS. 5A and 5B illustrate an audio plug connector 301 that includes a standard audio plug 310 configured to mate with and engage an audio receptacle, such as a headphone jack. As with other receptacle connectors discussed herein, a mating audio receptacle connector can include features such as a latching feature configured to mate with and engage a latching feature 330 of the audio plug connector 301. This plug connector embodiment illustrates the latching feature 330 extending about the entire circumference of the plug housing 320. Additionally, similar to the electrical connector 101′ shown in FIG. 2B, the latching feature 330 of the audio connector 301 can be configured to require relatively low force for inserting or coupling the audio plug connector 301 with a mating audio receptacle connector compared to a force required to separate or decouple the audio plug connector 301 from the audio receptacle connector. The audio plug connector 301 is also illustrated with a seal 340 operable to interface with a receptacle housing associated with a mating audio receptacle to form a seal between audio plug housing 320 and the receptacle housing.

In accordance with one embodiment of the present invention, a method of facilitating an electrical connection is disclosed. The method can comprise providing an electrical plug connector configured to engage an electrical receptacle connector. The electrical plug connector can have an electrical plug, a plug housing fixedly coupled to the electrical plug with at least a portion of the electrical plug extending from the plug housing to allow the electrical plug to interface with an electrical receptacle of the electrical receptacle connector to form an electrical connection, and a low-profile latching feature extending outward from the plug housing. The method can further comprise facilitating engagement of the electrical plug connector with the electrical receptacle connector.

In one aspect, facilitating engagement of the electrical plug connector with the electrical receptacle connector can comprise configuring the latching feature of the plug connector to mate with and engage a latching feature of the electrical receptacle connector. In another aspect, facilitating engagement of the electrical plug connector with the electrical receptacle connector can comprise configuring the latching feature and the plug housing within an industry standard size envelope in at least one direction to ensure that the electrical plug connector is capable of interfacing with industry standard electrical receptacles without interference from the plug housing, the latching feature, or a second electrical plug connector. In an additional aspect, the electrical plug connector can further comprise a seal disposed about an exterior of the plug housing, the seal being exposed about the plug housing. Furthermore, facilitating engagement of the electrical plug connector with the electrical receptacle connector can comprise configuring the seal to interface with a receptacle housing of the electrical receptacle connector to form a seal between the plug housing and the receptacle housing.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

Accordingly, it is not intended that the invention be limited, except as by the claims set forth below.

What is claimed is:

1. An electrical plug connector, comprising:
an electrical plug;
a plug housing fixedly coupled to the electrical plug with at least a portion of the electrical plug extending from the plug housing to allow the electrical plug to interface with an electrical receptacle to form an electrical connection; and
a low-profile latching feature extending outward from the plug housing to engage a mating latching feature associated with the electrical receptacle.

2. The electrical plug connector of claim 1, further comprising a seal disposed about an exterior of the plug housing and operable to interface with a receptacle housing associated with the electrical receptacle to form a seal between the plug housing and the receptacle housing, the seal being exposed about the plug housing.

3. The electrical plug connector of claim 2, wherein the latching feature is defined, at least in part, by a reduced cross-sectional area portion formed in the plug housing.

4. The electrical plug connector of claim 3, wherein the reduced cross-sectional area portion is configured to at least partially receive the latching feature associated with the electrical receptacle.

5. The electrical plug connector of claim 3, wherein the latching feature of the plug housing is defined, at least in part, by a portion of the seal.

6. The electrical plug connector of claim 2, wherein the seal extends at least as far away from a surface of the plug housing as any portion of the latching feature.

7. The electrical plug connector of claim 1, wherein the latching feature comprises a plurality of non-contiguous portions extending from a surface of the plug housing.

8. The electrical plug connector of claim 7, wherein the plurality of non-contiguous portions comprise a first portion and a second portion extending from opposite sides of the plug housing.

9. The electrical plug connector of claim 1, wherein the plug housing and the latching feature are within an industry standard size envelope in at least one direction that ensures that the electrical plug is capable of interfacing with industry standard electrical receptacles without interference from the plug housing, the latching feature, or a second electrical plug connector.

10. The electrical plug connector of claim 1, wherein the latching feature is elastically deformable to facilitate engagement with the mating latching feature associated with the electrical receptacle.

11. An electrical connector system, comprising:
an electrical receptacle connector having an electrical receptacle and a receptacle latching feature extending from the electrical receptacle; and
an electrical plug connector operable to engage the electrical receptacle connector, the electrical plug connector having
an electrical plug,
a plug housing fixedly coupled to the electrical plug with at least a portion of the electrical plug extending from the plug housing to allow the electrical plug to interface with the electrical receptacle to form an electrical connection, and
a plug latching feature extending outward from the plug housing and operable to engage the receptacle latching feature to secure the electrical plug connector to the electrical receptacle connector.

12. The electrical connector system of claim 11, further comprising a cover operable to protect the electrical receptacle from environmental conditions, the cover having a cover latching feature operable to engage the receptacle latching feature of the electrical receptacle connector.

13. The electrical connector system of claim 11, wherein the receptacle latching feature is located in a position offset from an open end of the electrical receptacle.

14. The electrical connector system of claim 11, wherein the electrical receptacle connector further comprises a seal operable to interface with the plug housing to seal the electrical receptacle connector and the electrical plug connector.

15. The electrical connector system of claim 11, wherein the electrical plug connector further comprises a seal disposed about an exterior of the plug housing, the seal being operable to interface with a receptacle housing of the electrical receptacle connector to form a seal between the plug housing and the receptacle housing, the seal being exposed about the plug housing.

16. The electrical connector system of claim 11, wherein the receptacle latching feature comprises a plurality of non-contiguous portions extending from a receptacle housing of the electrical receptacle connector, and wherein the plug latching feature comprises a plurality of non-contiguous portions extending from the plug housing operable to engage the non-contiguous portions of the receptacle latching feature.

17. A method of facilitating an electrical connection, comprising:
providing an electrical plug connector configured to engage an electrical receptacle connector, the electrical plug connector having
an electrical plug,
a plug housing fixedly coupled to the electrical plug with at least a portion of the electrical plug extending from the plug housing to allow the electrical plug to interface with an electrical receptacle of the electrical receptacle connector to form an electrical connection, and
a low-profile latching feature extending outward from the plug housing; and
facilitating engagement of the electrical plug connector with the electrical receptacle connector.

18. The method of claim 17, wherein facilitating engagement of the electrical plug connector with the electrical receptacle connector comprises configuring the latching feature to mate with and engage a latching feature of the electrical receptacle connector.

19. The method of claim 17, wherein facilitating engagement of the electrical plug connector with the electrical receptacle connector comprises configuring the latching feature and the plug housing are within an industry standard size envelope in at least one direction to ensure that the electrical plug connector is capable of interfacing with industry standard electrical receptacles without interference from the plug housing, the latching feature, or a second electrical plug connector.

20. The method of claim 17, wherein the electrical plug connector further comprises a seal disposed about an exterior of the plug housing, the seal being exposed about the plug housing, and
wherein facilitating engagement of the electrical plug connector with the electrical receptacle connector comprises configuring the seal to interface with a receptacle housing of the electrical receptacle connector to form a seal between the plug housing and the receptacle housing.

21. An electrical plug connector, comprising:
an electrical plug;
a plug housing fixedly coupled to the electrical plug with at least a portion of the electrical plug extending from the plug housing to allow the electrical plug to interface with an electrical receptacle to form an electrical connection; and
a seal disposed about an exterior of the plug housing and operable to interface with a receptacle housing associated with the electrical receptacle to form a seal between the plug housing and the receptacle housing, the seal being exposed about the plug housing.
